(19) United States
(12) Patent Application Publication
(10) Pub. No.: US 2024/0293838 A1
(43) Pub. Date: Sep. 5, 2024

(54) FORMATION OF AN ABRADABLE COATING INSIDE A TURBOMACHINE CASING

(71) Applicant: SAFRAN AIRCRAFT ENGINES, Paris (FR)

(72) Inventors: Serge Emmanuel DOMINGUES, Moissy-Cramayel (FR); Guillaume Julien ABADIE, Moissy-Cramayel (FR); Alexandre Bernard Marie BOISSON, Moissy-Cramayel (FR); Gregory HEBERT, Moissy-Cramayel (FR)

(21) Appl. No.: 18/699,567

(22) PCT Filed: Oct. 5, 2022
(86) PCT No.: PCT/FR2022/051878

§ 371 Date: Apr. 8, 2024

(30) Foreign Application Priority Data
Oct. 12, 2021 (FR) FR2110756

(51) Int. Cl. B05C 7/06; B05C 7/00; F01D 25/24

(52) U.S. Cl. CPC B05C 7/06; B05C 7/005; F01D 25/24; F05D 2230/90

(57) ABSTRACT

A tool for forming an abradable coating in an aircraft turbine engine module, this module having an annular stator casing and a central rotor which can move inside the casing about an axis, wherein it has a first portion which is attached to the rotor, a second portion which includes at least one first trans-verse arm extending radially outwards and carrying spreading rollers, and a flywheel centered on the axis and configured to be rotated manually by an operator in order to rotate the tool and the rotor within the casing, so that the spreading rollers are capable of spreading a resin in order to form the coating.

### TECHNICAL SCOPE OF THE INVENTION

The present invention relates in particular to a tooling and a process for forming an abradable coating inside an annular casing of an aircraft turbomachine module.

### TECHNICAL BACKGROUND

The technical background comprises in particular documents CN-U-207 154 055, CN-U-207154 054, FR-A-1 124 416 and JP-B1-S49 27410.

A turbomachine comprises at its upstream end (with reference to the flow of gases in the turbomachine) a fan comprising a bladed wheel which is surrounded by a casing, called a retention casing because of its function of retaining the blades in the event of their breaking.

In a known way, the impellers of a turbomachine are surrounded by a stator which has an annular coating of abradable material. The coating extends around and at a short radial distance from the blades, which can rub against the material during operation and wear it away through friction. This optimises the radial clearances between the blades and the surrounding stator and therefore limits gas leakage at the radially outer tips or ends of the blades.

In the case of a retention casing, the fan blades are surrounded by an abradable layer which covers an internal annular surface of the casing. In the current technique, this abradable layer is obtained by spreading a polymerisable resin on the surface. This resin is manually hammered to remove as many air bubbles as possible and to bond the resin to the casing. It is then finished by calendering using a straight edge, with no control over the force applied. What's more, this calendering tends to impose a peeling force on the resin. It is therefore a manual operation that requires know-how that takes a long time to acquire, making it time-consuming and costly to implement.

The Applicant has already proposed in application WO-A1-2016/203141 a device for coating a turbomachine casing, which comprises means for depositing resin and means for spreading this resin. These spreading means comprise rollers. This device enables to replace the manual operations of the previous technique with automated operations that are therefore easier to reproduce. The device also comprises means for unwinding a plastic film intended to be inserted between said rollers and the resin. The plastic film prevents the resin from sticking to the rollers and ensures that the abradable coating has a good surface finish (e.g., smooth and glossy).

This application also describes an installation comprising the device and a transport carriage comprising means for rotating the casing about a horizontal axis. The device is intended to be attached to the carriage and the casing is rotated about the horizontal axis so that the resin is deposited and spread in the casing, these steps being automated.

The Applicant has also already proposed in application FR-A1-3 048 018 a device for applying abradable material to a surface of a turbomachine casing. This device comprises a number of guide means and means for adjusting the position of a spreading roller.

The Applicant now proposes an improvement to these devices. The aims of this improvement are to simplify the formation of the coating and to guarantee the reproducibility of this formation.

### SUMMARY OF THE INVENTION

The invention thus proposes a tooling for forming an abradable coating in an aircraft turbomachine module, this module comprising an annular stator casing and a central rotor which can move inside the casing about an axis, characterized in that it comprises:
a first portion which is configured to be centred and secured to the rotor,
a second portion which comprises at least a first transverse arm extending radially outwards and which carries spreading rollers, and
a flywheel centred on said axis and configured to be rotated manually by an operator in order to rotate the tooling and the rotor inside the casing, so that the spreading rollers are capable of spreading a resin in order to form said coating.

As mentioned above, the abradable coating is obtained by spreading a previously prepared resin, for example by mixing two or more components. This resin is generally in the form of a paste and is deposited on the internal surface of the casing. The resin can be deposited manually by an operator. As in the prior art, the resin is spread by rollers. According to the invention, the rollers are carried by the tooling, which is rotated by a flywheel and therefore directly by an operator. This operation is not automated, as human intervention is important to ensure good spreading quality. The tooling is integral with the rotor of the module and therefore rotates with this rotor inside the casing, which remains fixed. Unlike previous technology, it is the rollers that are mobile around the same axis, and it is the casing of the module that is fixed. It is simpler and more precise to use the casing as a fixed reference point and to rotate the tooling with the module rotor, to also guarantee good quality resin spreading and coating formation. The invention thus enables to significantly simplify the tooling, facilitate its use and also improve the final quality of the abradable coating.

The tooling according to the invention can be used to spread a resin and form an abradable coating from this resin, inside any turbomachine casing. This could be, for example, but without limitation, a casing for retaining the blades of a turbomachine fan.

The tooling according to the invention may comprise one or more of the following features, taken in isolation from each other, or in combination with each other:
the first portion comprises securing hooks which are distributed around the axis and which are configured to cooperate with said rotor in order to secure the tooling to the rotor;
the first portion comprises centring lugs which are distributed around the axis and which are configured to cooperate with said rotor in order to ensure that the tooling is centred on the rotor;
the hooks and/or lugs are located on a circumference centred on said axis, which has a first diameter, and the flywheel has a second diameter which is greater than the first diameter;
the first portion comprises support pins or orifices which are parallel to said axis;
the tooling comprises a second transverse arm which is diametrically opposed to the first arm with respect to said axis, and which carries at least one counterweight;
the tooling further comprises a lever for adjusting the radial position of said rollers with respect to said axis;

The present invention also relates to an assembly comprising a tooling as described above, with a transport carriage, said transport carriage comprising a frame, castors secured to the frame, a first space for housing said tooling, and at least one member for supporting the tooling in said first space so that the axis of the tooling is horizontal.

The assembly according to the invention may comprise one or more of the following features, taken in isolation from one another, or in combination with one another:
said support member comprises elements which are complementary to the pins or orifices and which are configured to cooperate by male-female engagement with these pins or orifices;
said support member comprises a fixed vertical upright, a plate which is mounted so that it can move in vertical translation on said upright and which carries said elements, and a crank for adjusting the position of the plate on the upright;
the assembly also comprises an annular protective shroud intended to protect said rotor, the transport carriage also comprising a second space for housing the shroud, and at least one member for supporting the shroud in said second space.

The present invention also relates to an installation for forming an abradable coating on the inside in an aircraft turbomachine module, this installation comprising an assembly as described above, and an aircraft turbomachine module, this module comprising:
a central rotor having an axis of rotation, and
an annular stator casing which extends around the axis and the hub, this casing comprising an internal annular surface onto which a resin is intended to be spread by the rollers of said tooling in order to form the coating.

The present invention also relates to a method of forming an abradable coating in an annular casing of an aircraft turbomachine module by means of an installation as described above, wherein it comprises:
a step a) of moving said assembly towards the module,
a step b) of aligning the axis of the tooling with the axis of the rotor,
a step c) of securing the first portion of the tooling to the hub of the rotor,
a step d) of removing the carriage from the module,
a step e) of depositing resin on the surface of the casing, this step may be carried out before one of the preceding steps,
a step f) of manual rotation by an operator of the tooling and the rotor inside the casing, by means of the flywheel, so as to spread the resin with the rollers on the surface of the casing,
a step g) of supporting the tooling by the carriage,
a step h) of disconnecting the tooling from the rotor,
a step i) of removing the tooling from the module by means of the carriage.

The method according to the invention may comprise one or more of the following features or steps, taken separately or in combination with one another:
the method comprises, before step a), or between steps a) and b) or b) and c), a step of securing the shroud to the hub of the module;
the method comprises, between steps d) and e) or e) and f), a step of setting the radial position of the rollers relative to the axis of the rotor;
step e) is carried out manually by an operator.

### BRIEF DESCRIPTION OF THE FIGURES

Further features and advantages will be apparent from the following description of a non-limiting embodiment of the invention with reference to the appended drawings in which:

FIG. 1 is a schematic perspective view of an annular casing of a turbomachine, this casing having an internal abradable coating;

FIG. 2 is a schematic half-view of the casing in FIG. 1 in axial section;

FIG. 3 is a schematic perspective view of an installation according to the invention, this installation comprising a turbomachine module and an assembly comprising a transport carriage and a tooling for forming the abradable coating;

FIG. 4 is a schematic side view of the installation shown in FIG. 3;

FIG. 5 is a larger-scale schematic perspective view of a detail of the tooling in FIG. 3 and shows the spreading rollers;

FIG. 6 is a schematic perspective view of the transport carriage of FIG. 3;

FIG. 7 is a schematic perspective view of the tooling of FIG. 3, and in particular of a rear face of this tooling;

FIG. 8 is a schematic perspective view of the tooling in FIG. 3, and in particular of a front face of this tooling;

FIG. 9 is a schematic perspective view of a detail of the tooling in FIG. 3, and shows securing and centring members;

FIG. 10 is a schematic perspective view of an annular shroud for the assembly according to the invention.

FIG. 11 is a schematic perspective view of a detail of the shroud of FIG. 10 when mounted in the module;

FIG. 12 is a schematic perspective view of the installation shown in FIG. 3, and illustrates a step in a process according to the invention;

FIG. 13 is a schematic front view of the tooling in FIG. 3, and illustrates a step in a process according to the invention;

FIG. 14 is a schematic perspective front view of the tooling and a portion of the module of FIG. 3, and illustrates a step in a process according to the invention;

FIG. 15 is a schematic front view of the tooling and of a portion of the module of FIG. 3, and illustrates a step in a process according to the invention;

FIG. 16 is a schematic perspective view of the tooling mounted on the module of FIG. 3, and illustrates a step of a process according to the invention; and

FIG. 17 is a schematic perspective view of the installation in FIG. 3, and illustrates a step in a process according to the invention.

### DETAILED DESCRIPTION OF THE INVENTION

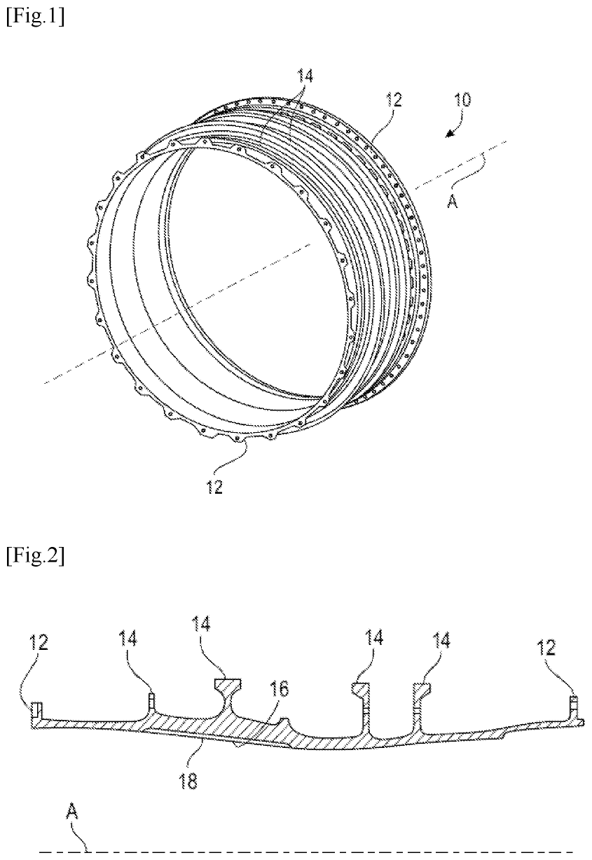

Reference is first made to FIGS. 1 and 2, which show an annular casing 10 of an aircraft turbomachine. Conventionally, a turbomachine comprises, from upstream to downstream, in the direction of flow of the gases, a fan, at least one compressor, an annular combustion chamber, at least one turbine, and a nozzle for ejecting the combustion gases.

The air flow passing through the fan is divided into a first air flow, known as the primary flow or hot flow, which enters the compressor, where it is compressed and then burnt in the chamber, before flowing into the turbine and being ejected through the nozzle, and a second flow, known as the secondary flow or cold flow, which flows between the engine (comprising the compressor, the combustion chamber and the turbine) and a nacelle of the turbomachine.

The fan comprises an impeller that rotates inside an annular casing such as that shown in FIG. 1, which is commonly referred to as a containment casing for the reasons given above.

The annular casing 10 is substantially cylindrical in overall shape with an axis of revolution A. It comprises an annular securing flange 12 at each of its axial ends. These flanges 12 are used to secure the casing 10 to annular walls of the turbomachine nacelle. The casing 10 may also comprise annular stiffeners 14.

The casing 10 comprises a radially inner annular surface 16 covered with an abradable coating 18 in the form of a layer of predetermined thickness. This coating 18 is continuous over 360° and has an axial length or dimension, along axis A, which represents 20 to 40% of the length of the casing in the example shown. This coating 18 is located close to the upstream end of the casing 10 and is intended to extend opposite the top of the blades of the fan wheel. The coating 18 is obtained by polymerisation of a resin which is prepared from at least two components.

The present invention proposes a tooling 20 for forming the coating, this tooling 20 being associated with a carriage 30 to form an assembly within the meaning of the invention, and the tooling 20 and the carriage 30 being further associated with a turbomachine module 40 to form an installation within the meaning of the invention.

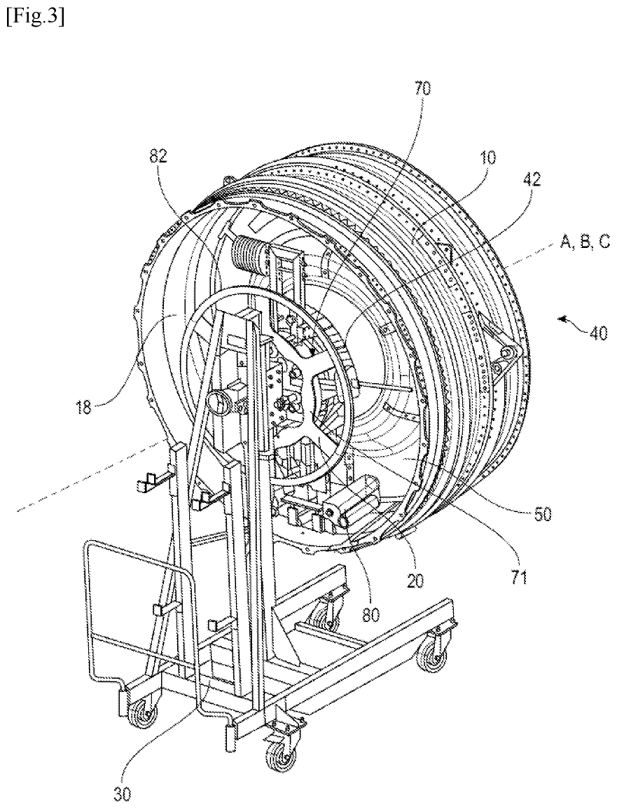

FIG. 3 et seq. illustrate an embodiment of the tooling 20, the carriage 30, the assembly and the installation.

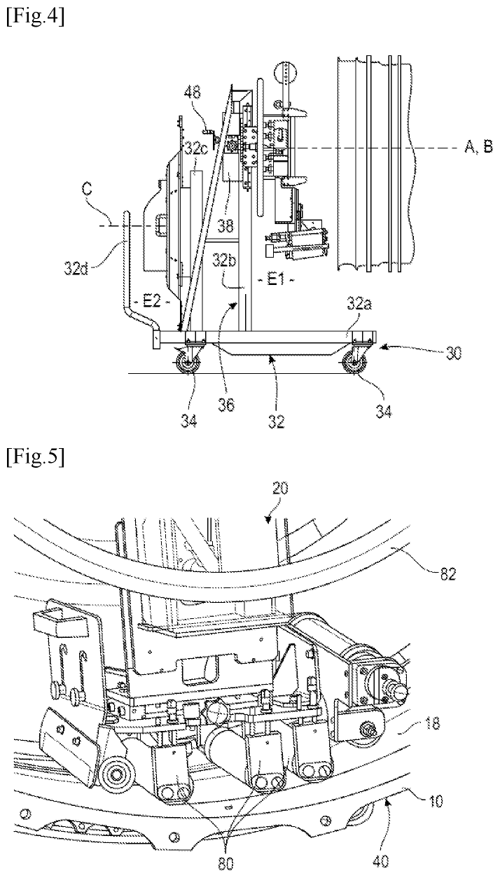

FIGS. 3 and 4 illustrate the installation as a whole, which comprises the tooling 20, the carriage 30 and the module 40.

The turbomachine module 40 is a fan module in the example shown. This module 40 comprises a central rotor 42 which has an axis of rotation A and an annular casing 10 which extends around the axis A and the rotor 42. The rotor 42 may be guided relative to the stator and the casing 10 by suitable means such as bearings which are not shown.

The casing 10 is similar to that described above in relation to FIGS. 1 and 2 and comprises an internal annular surface 16 covered by an abradable annular coating 18.

The module 40 is preferably kept raised off the ground by a suitable means such as a hoist, so that its axis A is oriented horizontally.

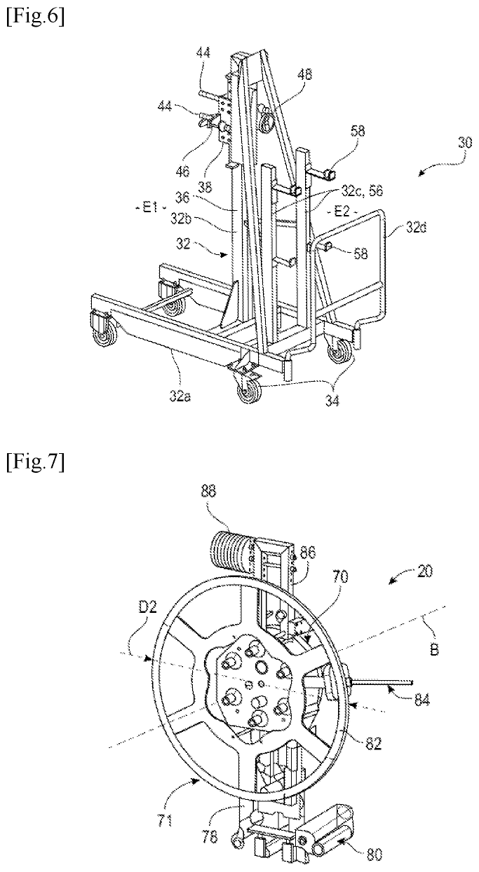

The carriage 30 can be seen alone in FIG. 6, and comprises a frame 32, castors 34 secured to the frame, a first space E1 for housing the tooling 20, and at least one member 36 for supporting the tooling 20 in this first space E1 so that the axis B of the tooling 20 is horizontal.

The frame 32 comprises a lower platform 32a to which the castors 34 are secured, and comprises vertical uprights 32b, 32c secured to the platform 32a, at least one of which forms the member 36 for supporting the tooling 20. The carriage 30 also comprises a bar 32d or handle for gripping and moving the carriage by an operator.

The upright 32b carrying the tooling 20 is fixed and has a vertical orientation. It carries a plate 38 which is mounted so that it can move in vertical translation on the upright 32b and which carries elements 44 for supporting the tooling 20. As can be seen in FIG. 6, these elements 44 comprise horizontally oriented pins.

In the example shown, the plate 38 also comprises locking elements 46 configured to cooperate with the tooling 20.

The upright 32 also comprises a crank 48 for adjusting the position of the plate 38 on the upright 32b, and therefore the vertical position of the plate 38.

As can be seen in FIG. 3, the assembly according to the invention also comprises an annular protective shroud 50 designed to protect the rotor 42 of the module 40.

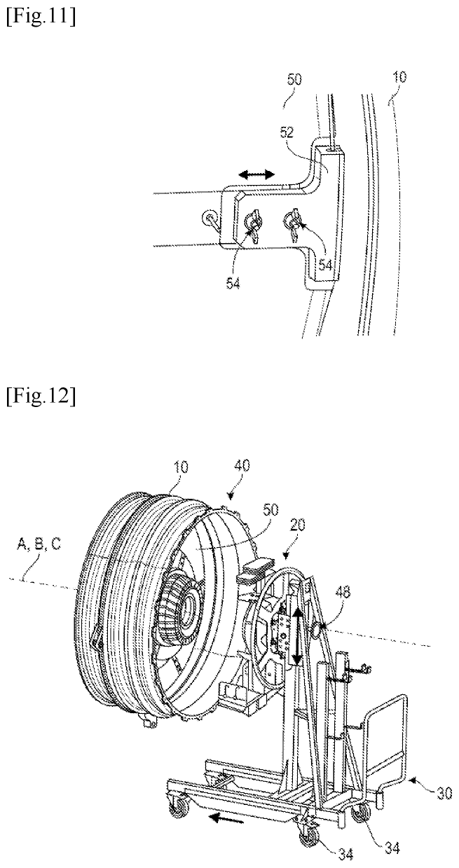

The shroud 50 is shown alone in FIG. 10 and comprises a disc pierced at its centre. The shroud 50 comprises lugs 52 on the outer periphery of the disc, which are evenly spaced around the axis of revolution C of the disc and can move in radial translation, as illustrated by the double arrow in FIG. 11. The radial position of each lug 52 on the disc is set and maintained by screws and wing nuts 54 for example.

These lugs 52 enable the shroud 50 to be held securely in the module 40 and on the rotor 42, as will be explained in more detail below.

The carriage 30 has a second space E2 for housing the shroud 50, and at least one member 56 for supporting the shroud 50 in this second space E2. This member 56 comprises vertical uprights 32c which carry hooks 58 for supporting the end shroud 50 in a position such that its axis of revolution C is substantially horizontal.

The tooling 20 comprises a first portion 70 which is configured to be centred and secured on the rotor 42 of the module 40.

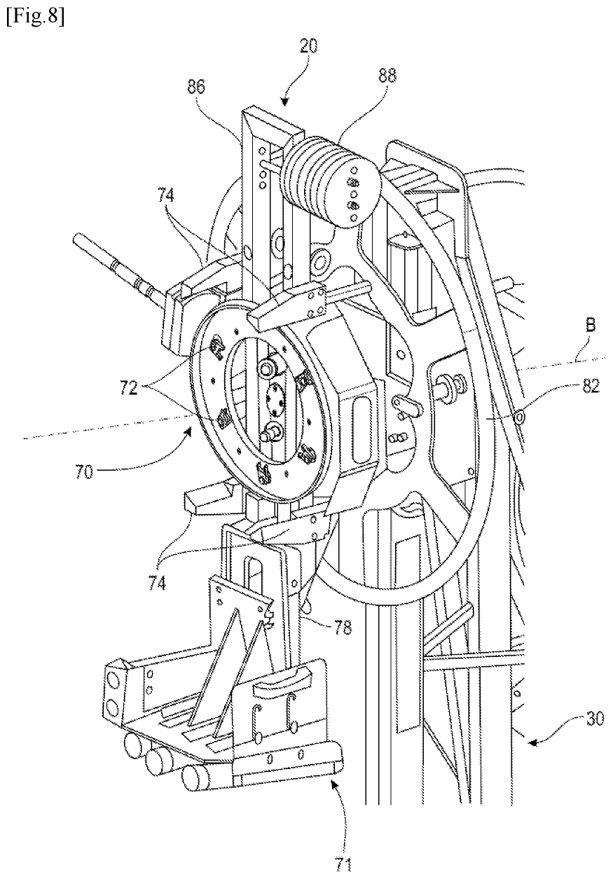

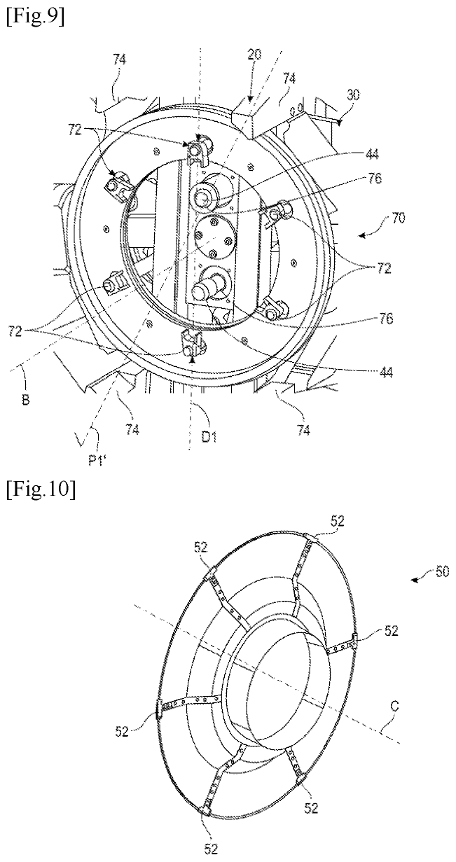

This first portion 70 is best seen in FIGS. 8 and 9 and preferably comprises:
securing hooks 72 which are distributed around the axis B and which are configured to cooperate with the module 40, and in particular its rotor 42, in order to ensure that the tooling 20 is secured to the module 40, and
centring lugs 74 which are distributed around the axis B and which are configured to cooperate with the module 40, and in particular its rotor 42, with a view to centring the tooling 20 on the module 40 so that the two axes A and B are aligned.

The hooks 72 are located on a circumference centred on axis B, which has a diameter D1 and the lugs 74 are located on a circumference centred on axis B, which has a diameter D1′ which is greater than D1 in the example shown.

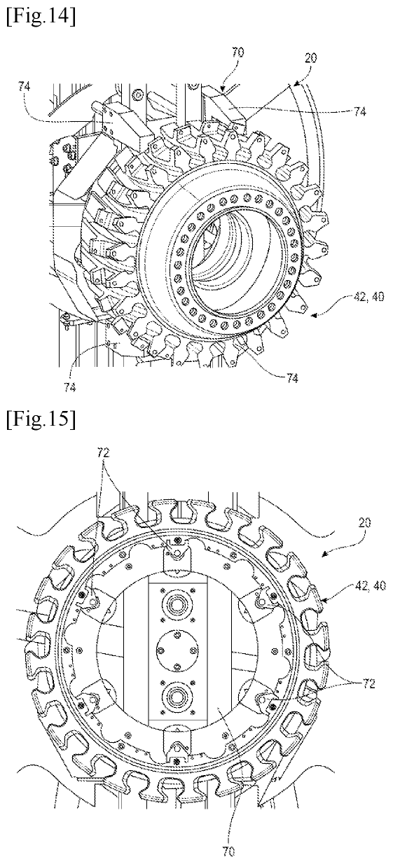

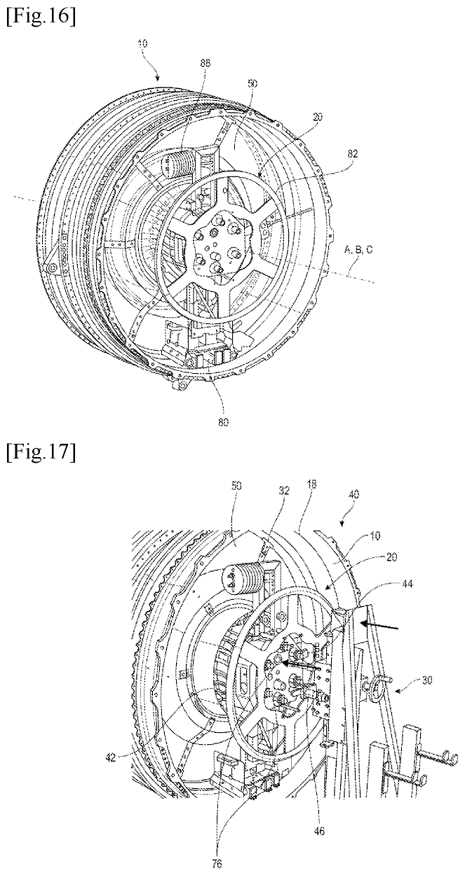

As can be seen in FIG. 15, the securing hooks 72 are engaged axially inside the rotor 42 and are configured to hook onto the inner periphery of this rotor. FIG. 14 shows that the centring lugs 74 cooperate with the outer periphery of the rotor 42 to ensure that it is centred.

The first portion 70 also comprises orifices 76 extending parallel to the axis B and serving to support the tooling 20. These orifices 76 are configured to cooperate by male-female engagement with the aforementioned pins 44 of the carriage 30, as illustrated in FIG. 9.

The tooling 20 comprises a second portion 71 which is fixed relative to the first portion 70. This second portion 71 of the tooling 20 is best seen in FIG. 7 and preferably comprises at least a first transverse arm 78 extending from axis B radially outwards and carrying spreading rollers 80.

The tooling 20 also comprises a flywheel 82 centred on the axis B and configured to be manipulated manually by an operator in order to rotate the tooling 20, which is integral with the rotor 42 inside the casing 10.

In the example shown, the flywheel 82 has a diameter D2 which is greater than D1 and D1′.

The rollers 80 are visible in detail in FIG. 5 and were developed as part of another invention of the Applicant. The rollers 80 will therefore not be described in further detail below and are comparable to those described in WO-A1-2016/203141 or FR-A1-3 048 018. The rollers 80 may be associated with means for scraping, unwinding a plastic film, cutting, etc., as can be seen in the drawing.

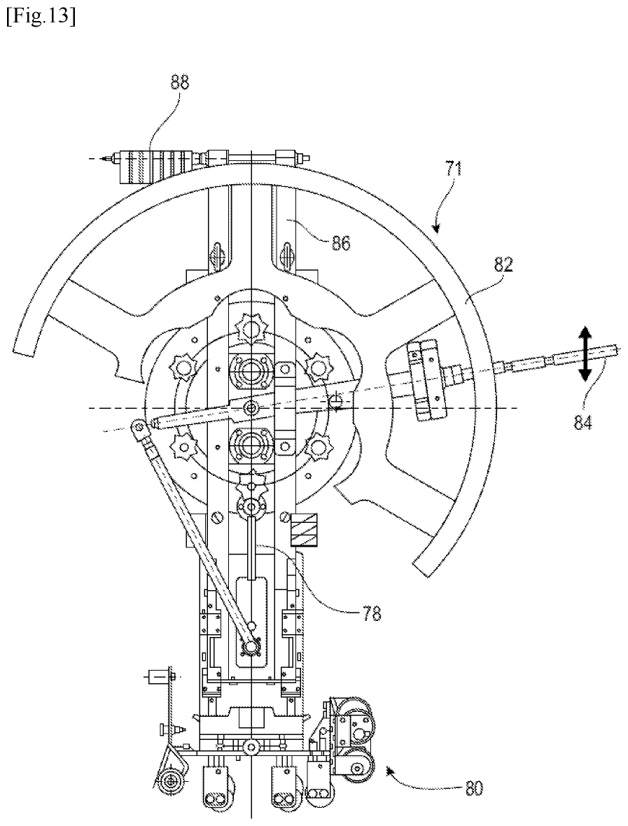

In the example shown, the rollers 80 are located at a radially outer end of the arm 78. The radial position of the rollers 80 relative to the axis A, B is preferably set by means of an adjusting lever 84, visible in particular in FIGS. 7, 8 and 13. This lever 84 can be moved from a stowed, non-functional position in which it extends, for example, to one side of the tooling 20, to a deployed, functional position in which it extends radially outwards and can be manipulated by an operator. Actuation of the lever 84 causes the rollers 80 on the arm 78 to move in a radial direction (see FIG. 13).

In the example shown, the tooling 20 also comprises a second transverse arm 86 which is diametrically opposed to the first arm 78 with respect to the axis B, and which carries at least one counterweight 88.

Movement of the tooling 20 about the axis A, B causes the arms 78, 86 to rotate about this axis and inside the casing 10. The counterweight 88 compensates for the weight of the rollers 80 and enables the operator to manipulate the flywheel 82 without significant effort.

A method of implementing the invention will now be described with reference to FIG. 12 and following.

With reference to FIG. 12, the process comprises the following steps:
a step a) of moving the assembly formed by the carriage 30 and the tooling 20, and possibly the shroud 50, towards the module 40, and
a step b) aligning the axis B of the tooling 20 with the axis A of the rotor 42.

Step a) is carried out manually by an operator who moves the carriage 30 using its castors 34. Step b) is also performed by the operator using the crank 48 on the tooling 20.

Between steps a) and b) or after step b), the process may include a step of securing the shroud 50 to the rotor 42. The rotor 42 passes through the centre of the disc of the shroud 50 and the lugs 52 are displaced radially to bear radially inside the casing 10, which holds the shroud 50 securely on the rotor 42 so that the axes A and C are aligned (see FIG. 11).

With reference to FIGS. 14 and 15, the method then comprises the following steps:
a step c) of securing the portion 70 of the tooling 20 to the rotor 42 of the module 40, as described above, and
a step d) of removing the carriage 30 from the module 40.

With regard to step d), it is then sufficient to unlock the carriage 30 from the tooling 20 using the elements 46, then to pull the carriage away from the module 40 so that the pins 44 of the carriage slide in the orifices 76 of the tooling and are extracted from these orifices (see FIGS. 6 and 9).

The process also includes a step e) of depositing resin on the surface 16 of the casing 10, preferably manually by an operator who previously prepares the mixture of components for making this resin. This step can be carried out in advance.

The process preferably comprises, between steps d) and e) or after step e), a step of setting the radial position of the rollers 80 with respect to the axis A, B, as illustrated in FIG. 13. This enables the rollers 80 to be positioned precisely inside the module 40 and with a predetermined radial clearance relative to the surface 16 of the casing. This clearance is determined as a function of the desired thickness of the coating 18 on the surface 16.

The process then comprises a step f) of manual rotation by an operator of the tooling 20 and the rotor 42 inside the casing 10, by means of the flywheel 82, so as to spread the resin with the rollers 80 over the surface 16 of the casing 10.

The resin can be spread over 360° or less on the surface 16.

Once the resin has been spread, the process includes a step g) of supporting the tooling 20 by the carriage 30, which is illustrated in FIG. 17. For this, the carriage 30 is moved by the operator so as to align the pins 44 of the carriage 30 with the orifices 76 of the tooling, and then to engage the pins 44 in the orifices 76.

The method then comprises:
a step h) of disconnecting the tooling 20 from the rotor 42, i.e. the securing hooks 72 are disconnected from the rotor 42, then
a step i) of removing the tooling 20 and the assembly from the module 40, using the carriage 30 handled by the operator.

The tooling 20 according to the invention can be used to form an abradable coating 18 in a casing being manufactured or in a casing being maintained, the latter having undergone prior removal of its worn abradable coating, for example.

1. A tooling for forming an abradable coating in an aircraft turbomachine module, this module comprising an annular stator casing and a central rotor which can move inside the casing about an axis, comprising:
a first portion which is configured to be centered and secured to the rotor,
a second portion which comprises at least a first transverse arm extending radially outwards and which carries spreading rollers, and
a flywheel centered on said axis and configured to be rotated manually by an operator in order to rotate the tooling and the rotor inside the casing, so that the spreading rollers are capable of spreading a resin in order to form said coating.

2. The tooling according to claim 1, wherein the first portion comprises:
securing hooks which are distributed around the axis and which are configured to cooperate with said rotor in order to secure the tooling to the rotor, and/or
centring lugs which are distributed around the axis and which are configured to cooperate with said rotor in order to ensure that the tooling is centered on the rotor.

3. The tooling according to claim 2, wherein the hooks and/or the lugs are located on a circumference centered on said axis, which has a first diameter, and the flywheel has a second diameter which is greater than the first diameter.

4. The tooling claim 1, wherein the first portion comprises support pins or orifices which are parallel to said axis.

5. The tooling claim 1, wherein the tooling comprises a second transverse arm which is diametrically opposed the first arm with respect to said axis, and which carries at least one counterweight.

6. The tooling claim 1, wherein the tooling further comprises a lever for adjusting the radial position of said rollers with respect to said axis.

7. An assembly comprising a tooling according to claim 1, with a transport carriage, said transport carriage comprising a frame, castors secured to the frame, a first space for housing said tooling, and at least one member for supporting the tooling in said first space so that the axis of the tooling is horizontal.

8. The assembly according to claim 7, the tooling comprising comprises support pins or orifices which are parallel to said axis, wherein said support member comprises elements which are complementary to the pins or orifices and which are configured to cooperate by male-female engagement with these pins or orifices.

9. The assembly according to claim 8, wherein said support member comprises a fixed vertical upright, a plate which is mounted so as to be movable in vertical translation on said upright and which carries said elements, and a crank for adjusting the position of the plate on the upright.

10. The assembly according to claim 7, wherein the assembly further comprises an annular protective shroud intended to protect said rotor, the transport carriage further comprising a second space for housing the shroud, and at least one member for supporting the shroud in said second space.

11. An installation for forming an abradable coating in an aircraft turbomachine module, said installation comprising an assembly according to claim 7, and an aircraft turbomachine module, this module comprising:
a central rotor having an axis of rotation, and
an annular stator casing which extends around the axis and the hub, this casing comprising an internal annular surface onto which a resin is intended to be spread by the rollers of said tooling in order to form the coating.

12. A method of forming an abradable coating in an aircraft turbomachine module by means of an installation according to claim 11, said method comprising:
a step a) of moving said assembly towards the module,
a step b) of aligning the axis of the tooling with the axis of the rotor,
a step c) of securing the first portion of the tooling to the rotor of the module,
a step d) of removing the carriage from the module,
a step e) of depositing resin on the surface of the casing, this step may be carried out before one of the preceding steps,
a step f) of manual rotation by an operator of the tooling and the rotor inside the casing, by means of the flywheel, so as to spread the resin with the rollers on the surface of the casing,
a step g) of supporting the tooling by the carriage,
a step h) of separating the tooling from the rotor,
a step i) of removing the tooling from the module by means of the carriage.

13. The method according to claim 12, wherein, the method comprises, before step a), or between steps a) and b) or b) and c), a step of securing an annular protective shroud intended to protect said rotor to the rotor.

14. The method according to claim 12, wherein it the method comprises, between steps d) and e) or e) and f), a step of setting the radial position of the rollers relative to the axis of the rotor.

15. The method according to claim 12, wherein the step e) is carried out manually by an operator.
